(19) United States
(12) Patent Application Publication
(10) Pub. No.: US 2014/0244487 A1
(43) Pub. Date: Aug. 28, 2014

(54) Fund Transfer Using Near Field Communication

(71) Applicants: Maxwell Seligmann, Essex Fells, NJ (US); Cameron Seligmann, Essex Fells, NJ (US)

(72) Inventors: Maxwell Seligmann, Essex Fells, NJ (US); Cameron Seligmann, Essex Fells, NJ (US)

(21) Appl. No.: 14/192,484

(22) Filed: Feb. 27, 2014

Related U.S. Application Data
(60) Provisional application No. 61/770,708, filed on Feb. 28, 2013.

(51) Int. Cl. G06Q 20/32; G06Q 20/10

(52) U.S. Cl. CPC G06Q 20/3278; G06Q 20/10
USPC 705/39

(57) ABSTRACT

Provided is a system and method for transferring change or coin value due to a first user as a result of a cash transaction where the system allows for reading of a signal or identifier from a first user device such as a smart phone to determine what funds are being requested for transfer. The system transfers funds from a second user such to the first user according to the requested amount of funds. The system further allows for verification and confirmation of the transfer and updating of the second user computer to show if any cash in the form of bills is due to the user. The funds may be transferred into a provider-managed account. Further, the system can calculate and deduct service fees at various points in the transaction cycle.

### FIELD OF THE INVENTION

The present invention relates to electronic fund transfer and payment processing systems. More particularly, the present invention relates to systems and methods for transferring funds using near field communication.

### BACKGROUND OF THE INVENTION

As near field communication systems become more and more prevalent in smart phones, tablet computers and the like, users of such devices have begun to receive and accept payments using near field communication protocols. Many of these protocols or standards are being set or are currently under development. For example, the SD Association (SDA) and/or Near Field Communication Forum (NFC Forum) may set certain standards that allow mobile devices to communicate with each other or with Near Field Communication systems. This communication typically takes place over limited or short ranges for purposes of transferring or receiving various data, requests or queries. As an example only, such limited or short range may be less than 12 inches, or more particularly 0-2 inches.

Many people will still regularly use cash to complete various transactions. With these cash transactions, change is commonly returned in the form of small bills and/or coin. Often, individuals receiving coinage will loose coins or simply place them in a jar for later use. But, many individuals do not end up actually using the coins and they will simply sit in the jar for an extended period of time. Some systems and machines have been developed to help consumers count and sort their change faster. For example, a Coinstar® machine will accept a number of coins at once for sorting and counting. Once counted, individuals may be able to receive the value of the coins predominantly in larger bills. But, these machines will often take a large percentage of the coin value. For example, fees of about 7% are not uncommon. Further, these machines must be emptied and/or filled with the appropriate cash and coin.

Other in home counting machines are known, and these machines have allowed individuals to sort coins into standard rolls to redeem at a bank. Although, these counting machines may provide a less expensive way to efficiently count coins, a trip to the bank is usually necessary to redeem the coins for larger bills or deposit. Further, there can be a substantial amount of time taken to count and organize all the coins in coin rolls.

Despite some counting options, the presently available systems still require that coins be saved, and in many cases, coins are mis-placed or lost, which can result in a substantial amount of lost money over time. Therefore, it is desirable to provide a system that allows cash transactions to reduce or eliminate the exchange of physical change and/or coins when an individual does not have (or use) exact change.

### SUMMARY OF THE INVENTION

Therefore, it is an object of the present invention to provide a system for transferring funds between two users.

It is yet another object of the present invention to provide a system for electronic transfer of coin or change value resulting from a cash transaction.

It is yet another object of the present invention to provide software for a user device that aids in the electronic transfer of coin or change value resulting from a cash transaction.

It is still another object of the present invention to provide software and/or hardware for a merchant computer such as a Point of Sale system where the software electronic transfer of coin or change value resulting from a cash transaction.

It is still another object of the present invention to provide a website for managing transferred funds as a result of the cash transactions managed by the system.

Therefore, the system may read a signal or identifier from a first user device such as a smart phone to determine what funds are being requested for transfer. The system transfers funds from the merchant to the customer according to the requested amount of funds. The system further allows for verification and confirmation of the transfer and updating of the point of sale system to show if any cash in the form of bills is due to the user. The funds may be transferred into a provider-managed account. Further, the system can calculate service fees at various points in the transaction cycle. For example, a service fee may be due upon initial transfer and another service fee may be due if a user wishes to transfer funds from the provider managed account to a third party managed account, such as another bank or financial institution.

As used herein, the following definitions shall apply:

The terms “first” and “second” are used to distinguish one element, set, data, object or thing from another, and are not used to designate relative position or arrangement in time.

The term “network” as used herein includes both networks and internetworks of all kinds, including the Internet, and is not limited to any particular network or inter-network.

The terms “user” or “users” mean a person or persons, respectively, who access the system in any manner, including through various user devices or computers, whether alone or in one or more groups, whether in the same or various places, and whether at the same time or at various different times.

Objects of the present invention are achieved by providing a system for transferring funds from a first user to a second user. The system may include software executing on a first user device for transmitting a funds request via a first wireless communication system. Software may execute on a second user computer for receiving the funds request from the first user device via a second wireless communication system. The funds request may be of at least part of a residual amount due to the first user as a result of a cash transaction with the second user. A system computer may be communication with the second user computer via a network. Software executing on said system computer may transmit a transfer request based on the funds request, the transfer request for electronically transferring the residual amount from a second user account to a first user account.

The system may include software executing on the system computer for generating a confirmation based on the transfer request, the confirmation indicative of a successful transfer of the residual amount from the second user account to the first user account.

The confirmation may be transmitted to at least one of the second user computer or the first user device. The residual amount may be the amount of change due to the first user as a result of a cash transaction with the second user. The residual amount may be the value of coins due to the first user as a result of a cash transaction with the second user.

The system may include software executing on the system computer for verifying an identity of the first user and associating the first user with the user account.

The system may include software executing on the system computer for deducting a service fee from the residual amount and transferring the service fee to a provider account, wherein the at least a part of the residual amount is the amount due to the first user as a result of the cash transaction less the service fee.

The funds request may be indicative of the value of coins due to the first user as a result of a cash transaction with the second user. The system may include software executing on the second user computer for displaying a cash value due to the first user as a result of the cash transaction, where the cash value is the residual amount minus coin value.

The second user account may include at least two accounts, one of the two accounts is a second user third party account, and one of the two accounts is a second user provider account. The system may further include software executing on the system computer for determining a balance of at least one of the two accounts. The system may include software executing on the system computer for comparing the residual amount to the balance and to determine which of the at least two accounts has sufficient funds for completing the transfer. The system may include software executing on the system computer for determining a service fee for each of the account based on an amount transferred from each of the two accounts. Further, the system may include software executing on the system computer for determining a percentage to deduct from each of the two accounts in order to obtain the lowest service fee.

The first and second wireless communication systems may communicate using near field communication.

Other objects are achieved by providing a computer implemented method for transferring funds from a first user to a second user, where the method may comprise the steps of: providing software executable on a processor of a first user device and for generating a funds request; receiving a funds request transmitted from the first user device to a second user device over a wireless communication system, the funds request indicative of at least part of a residual amount due to the first user as a result of a cash transaction with the second user; verifying an identity of the first user; and generating a transfer request based on the funds request, the transfer request indicative of a transfer and for electronically transferring at least part of the residual amount from a second user account to a first user account. The verifying step may be completed by receiving first user account information. A biometric sensor associated with a first user device may generate a first user identifier for transmission to the second user device; and wherein the first user identifier is used to complete the verifying step. The first or the second user device may complete verifying step using a biometric sensor. The biometric sensor may be a fingerprint sensor, retinal scanner, facial recognition sensor or combinations thereof.

The step of receiving a funds request may further include receiving a tip request indicative of a tip value that the first user would like to transfer to an individual associated with the second user computer. The method may further include electronically transferring coin value due to the first user after tips due to the first user account. The method may further include indicating on a display of the second user computer a cash value due to the first user after deduction of tips and coin value.

Other objects are achieved by providing a software application for transferring funds from a first user to a second user. The software application may include: software executing on a first user device for communicating with a second user computer via a wireless communication system; and software executing on the first user device for displaying two user selectable options. A first one of the options may be indicative of a fund request for requesting a change value due to the first user as a result of a cash transaction with the second user. A second one of the options may be indicative of a fund request for requesting a coin value due to the first user as a result of a cash transaction with the second user. The application may include software executing on the first user device for receiving a selection of one of the first or second options and for further transmitting the fund request associated with the selected option to the second user computer.

The application may include software executing on the first user device for displaying a service fee associated with the fund request associated with the selected option. Software may execute on the first user device for displaying a user selectable confirmation option. The application may include software executing on the first user device for receiving a selection of said confirmation option, the selection indicative of the first user's acceptance of the service fee, wherein the fund request is transmitted to the system computer upon receiving the selection of the confirmation option. The transfer request may be for transferring funds from a second user account to a first user account. The application may further include software executing on said first user device for receiving a verification identifier, wherein the verification identifier indicates that the individual associated with the first user account initiated the fund request. The verification identifier may be a fingerprint. It is understood that the fingerprint may be digital or a digital representation of the features of a fingerprint. A biometric sensor associated with the first user device may generate the verification identifier.

The application may further include a third user selectable option displayed on the user device, the third option indicative of a tip value the first user would like deducted from the residual amount due to the first user.

Other objects are achieved by providing system for transferring funds from a first user to a second user. The system may include a first user device having a first user identifier associated therewith the first user identifier associated with a first user account. A second user computer may have a wireless communication system associated therewith and for communication with the first user device in order to read the first user identifier from the first user device. The system may include software executing on the second user computer for communicating a fund request and the first user identifier to a system computer over a network connection, the fund request indicative of at least part of a residual amount due to the first user as a result of a cash transaction with the second user. The system may include software executing on the system computer for querying a database with the first user identifier to determine a first user setting, the first user setting indicative of if the first user would like either: a transfer of change to the first user account, or a transfer of coin value to the first user account. The system may further include software executing on the system computer for generating a transfer request based on the first user setting and for transferring at least part of the residual amount to the first user account.

The first user device may be a mobile computing device having a processor with software executing thereon; and the wireless communication system may be a near field communication system.

The system may further include software executing on the system computer for generating a confirmation based on the transfer request, the confirmation indicative of a successful transfer of the residual amount from the second user account to the first user account. The system may include software executing on the system computer for transmitting the confirmation to a mobile device associated with the first user. The mobile device may be the first user device.

The system may include software executing on the system computer for calculating a service fee associated with the transfer request. The system may include software executing on the system computer for transferring the service fee to a provider account.

The system may include software executing on the system computer for calculating a reward associated with the transfer request and for transferring the reward to a second user account.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

### BRIEF DESCRIPTION OF THE DRAWINGS

FIG. 1 is a block diagram showing aspects of the present invention.

FIG. 2 is a block diagram of an aspect of FIG. 1 and showing how funds are transferred between various accounts

FIG. 3 is a block diagram showing an exemplary method of FIG. 1.

FIG. 4 is a block diagram showing another exemplary method of FIG. 1.

FIG. 5 is a block diagram showing an exemplary method implemented by one of the devices of FIG. 1.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

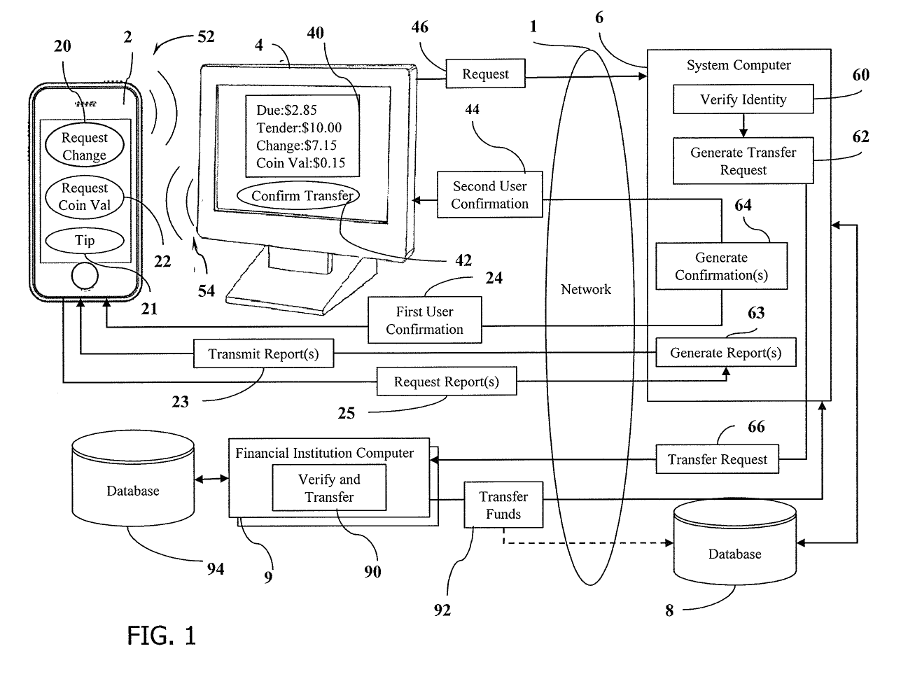

In FIG. 1, an example of a first user device 2 such as a smart phone with a touch sensitive screen is shown with application software installed thereon. It is understood that other devices such as tablets, laptops, cell phones and other devices can be used in the present system. Further, the system may be arranged to read an identifier from a user device such as a magnetic, RFID or other type of fob. In the example shown, application software allows the first user to press the Request Change 20 button or the Request Coin Val 22 button (“val” is an abbreviation for value). The application software may further allow the user to press a Tip button 21. This may allow the first user to transfer a percentage or other value to the second user or an individual associated with the second user such as a server or other individual who may receive a tip for service. It is contemplated that upon receiving a selection of the tip button, the application would allow the first user to select a percentage or value of the tip. Further, the system would allow the first user to request that coin value, change value or a portion thereof to be transferred to an individual associated with the second user. It is contemplated that this individual may also have an account that can receive funds and that the second user computer would transfer the appropriate tip value directly to the individual account. It is further contemplated that the system can generate reports 63 concerning transfer activity and coin values transferred to and from accounts. These reports can be generated on demand using user inputs such as a report request 25. In addition, the reports can be generated based on particular time periods, for example, monthly, yearly or other. The reports may show data such as total historical savings, transfers and tips given or received. These reports can be transmitted 23 to the user device. The reports may also be accessed through a website. Although FIG. 1 shows the reports transmitted to the first user device 2, it is contemplated that the report may be transmitted or accessed, imported or synchronized with a third party.

The system can also track cash expenditures to show how much was spent, where cash was spent, how much money was given as a tip, how much sales tax was paid, how much money was received into the first user account using the system and other metrics. These reports can be generated based on pre-set or user determined timelines, for example on a month to month basis. Further, the sales tax can be reported to the user on standard IRS reporting forms. In addition, the system may be designed to link with tax preparation services. For example, TurboTax® provides various online tax preparation software programs and systems, and in some cases the first user may wish to account for the sales taxes they have paid over the course of the a year as a deduction. Therefore, the system may be configured to transmit or allow various tax preparation providers and/or software to access the database to gather sales tax data for purposes of preparing tax returns.

It is also contemplated that the location of the user device or the set location of a user can be used to determine or allow for searching of locations where a user can use the system at various merchant locations or vending machines. These locations may be displayed in list or map form. It is further contemplated that an interface may be provided to allow the user to search by category or merchant type to determine those locations that use the system.

A wireless communication system 50 and 52 allows the first user device 2 to communicate with the second user computer 4. Therefore, when a user touches the screen at the buttons 20, 22, a fund request is communicated or transmitted from the first user device to the second user computer.

An exemplary second user computer 4 is shown with software installed and executing thereon. This second user computer may be a Point of Sale “POS” system commonly found in many retail, restaurant and wholesale locations. This POS system allows a clerk or a second user to input items that the first user would like to purchase. Once there is a total, the first user will typically have an option to pay with cash. In many cases, the first user will not have exact change and therefore as shown, if the amount of purchase is $2.85 and the first user tenders $10.00 to the clerk, the clerk will input the amount tendered into a keyboard, or touch pad. It is understood that the POS system can also include a touch sensitive screen, a keyboard or other device that allows the store clerk to input items, amount tendered and other information concerning the transaction.

As shown in FIG. 1, a touch sensitive button to confirm transfer 42 may be displayed on the POS system, and this button 42 may be pressed to allow clerk to confirm that a residual amount will be transferred to an account associated with the first user. In the example shown, when the first user presses the request change button 20, the change amount of $7.15 will be transferred to the first user account less any service or other fees.

It is understood that the term “button” used herein may indicate an area or icon on a screen that can somehow be selected. In other examples “button” may indicate a mechanical button that is depressed or otherwise actuated. One of skill in the art would understand that the term button would encompass various devices, computers and other means that can interact with the system. In some cases, the device used to communicate the funds request to the second user computer may simply be a key fob or keycard that uses magnetic, radio or other identifiers to associate a request with a particular account. The key fob example may use a radio, magnetic or other reader that is connected to or part of the POS system. This reader may sense the presence of the key fob and read the identifier to create the funds request. It is understood that the key fob may be set to automatically request certain values to be transferred to the first user account. For example, a web interface may request login or other identifier information, and settings for particular key fobs may be changed. In one example, the setting for the key fob could indicate that any time the key fob is sensed by the reader, it would indicate a funds request for the coin value as discussed and shown FIG. 1. It is understood that each transaction may have a different coin and/or change value and therefore display area 40 is exemplary only.

When the funds request is confirmed, the second user device 4 transmits the funds request 46 to the system computer 6 over a network 1. It is understood that the system computer may be associated with an individual or an entity referred to herein as a provider. The system computer may verify the identity 60 of the first user and generate a transfer request 62. The verification and transfer generation may be accomplished using information stored in the database 8. This database may be accessed by the software executing on the system computer that can generate and/or verify as discussed. The transfer request 66 is transmitted to a financial institution 9 computer and a funds transfer 92 is transmitted to the system computer. Financial institution computer 9 would be associated with the second user, and thus provide access to funds in a second user account. The financial institution computer may verify and transfer the funds 90 as shown. It is also understood that the funds transfer 92 may be sent to a second financial institution computer that is associated with the provider and therefore the system computer, and a confirmation of the transfer is sent by the financial institution computer 9 to the system computer or to the second financial institution computer (which likewise sends a confirmation to the system computer. The financial institution 9 may have a database 94 for tracking various transfers and account balances, and this database may be updated with the details of the transfer. Once the transfer of funds between the financial institution of the second user and the financial institution of the provider is completed, the system computer 64 may generate confirmation(s) 24, 44 respectively for the first and second user. It is understood that completion of the transfer may indicate that the transfer is still processing or pending final movement of the funds, but that the transfer will happen and funds will be transferred as requested by the system.

The software of the first user device and the second user computer can display the respective confirmations. Also, the database 8 is updated with the transfer details. In some cases, the transferred funds will remain with the provider and be marked or associated with various users of the system so that each user may access the change or coin values transferred over time. It is also contemplated that a web interface or application interface may be set to allow any of the users to request transfer of all or part of their funds from the provider to a financial institution, bank or Automatic Teller Machine.

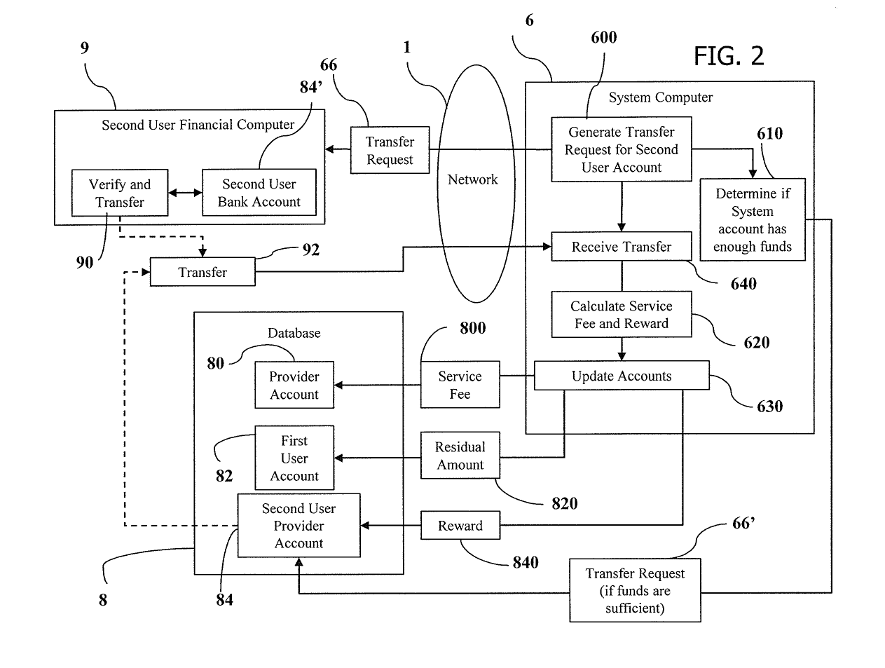

In FIG. 2, the second user financial computer 9 is shown receiving the transfer request 66 over the network 1. This transfer request 66 in some cases would be routed to the database 8 that tracks the provider managed accounts of the various users. The transfer request 600 is generated and the system determines if the second user provider account 84 has sufficient funds to cover the transfer. The transfer request 66 or 66′ may be transmitted to the second user financial computer 9 or the second user provider account 84 as appropriate. Accordingly, the transfer 92 is completed and received 640 by the system computer. Service fees and rewards 620 are calculated and accounts are updated. The service fee 800 is transferred or marked for the provider account 80, the residual amount 820 is transferred or marked for the first user account 82. The reward 840 is transferred or marked for the second user provider account. It is further understood that the database 8 may be accessible over a network connection and the database may be one or multiple databases, for example, cloud computing databases. Although FIG. 2 shows the reward 840 transferred to the second user provider account, it is also contemplated that rewards may be given to the first user based on a number of factors, for example, the usage at particular merchants, or the total usage of the system. For example, if the system tracks that the user has spent a threshold dollar amount or received a certain amount of change through the system, a reward such as a coupon, gift card or other reward can be given or transferred to the user. The gift card can be in the form of an electronic gift card that is transferred to an account that is associated with the first user and allows for electronic payment using a device such as the first user device. For example, this electronic gift card may be designed to increase available balance at certain stores, and this electronic gift card may be designed to work with NFC payment systems.

The service fee can change or be calculated on a sliding scale dependent on the amount of money transferred in the individual transfers. Further, the sliding scale can take into account the daily, weekly, monthly, yearly or lifetime totals of transfers using the system to provide lower service fees for example, when a user increasingly has higher amounts transferred.

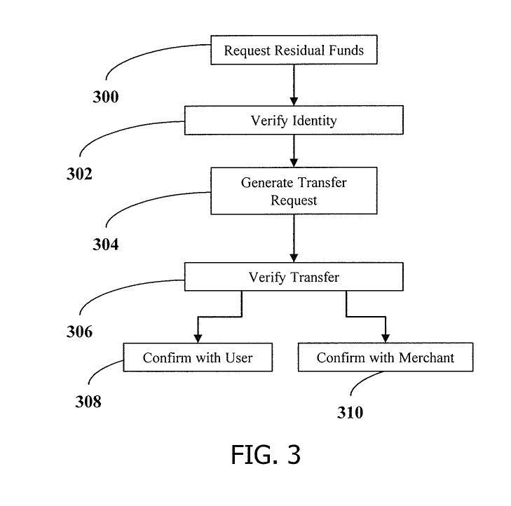

In FIG. 3 a residual funds request 300 is received. The identity of the requestor is verified 302. In order to verify the request, various sensors or passwords can be used. For example, a finger print sensor can be used in order to create the residual funds request, and a verification code or verification identifier can be submitted with the funds request. Therefore, when generating the transfer request 304, the identity of the requestor is known and the appropriate account information can be accessed from a database or other storage. The success or status of the transfer is verified and then a confirmation is sent to the user 308 and the merchant 310. Once the verification is received by the user and/or merchant, the POS system is updated to indicate what funds if any should be returned to the first user. For example, if the first user requested a coin value transfer, the user would still be owed cash. In the example displayed on the POS system in FIG. 1, once the coin value has been transferred, the clerk would still need to give the first user $7.00 to complete the transaction.

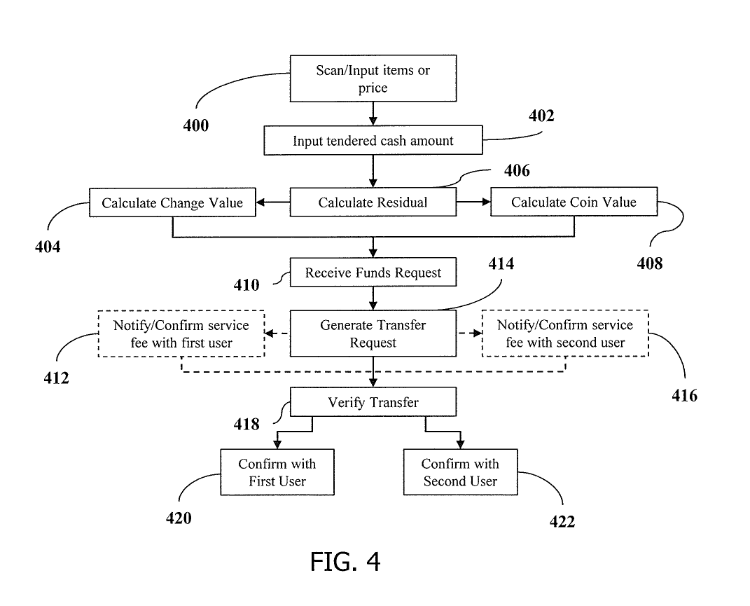

FIG. 4 shows an exemplary method which may be implemented by the second user computer. Items or services purchased are scanned or input 400 in to the computer. The system receives an input indicative of the tendered cash amount 402. In some cases, the system computer may be associated with a vending machine that receives cash, therefore, cash may be received, counted and processed by the vending machine and the input 402 may be received based on the counting and processing of cash. The residual value 406 is calculated based on the amount tendered and the total price of the items. The coin value 408 and the change value 404 are calculated system computer. A funds request is received 410 and the funds request may be indicative of the coin or the change value. The system computer generates a transfer request 414. Optionally, the service fee is confirmed with the first user 412 and the second user 416. The transfer is verified 418 and confirmed with the first user 420 and the second user 422. If the first user requests coin value, the second user computer can update the amount due to the first user, for example, upon receiving the confirmation that the transfer is processing, was processed or completed. The second user computer would then display a cash value due to the first user. It is also contemplated that tip value associated with the transfer can be taken into account such that the tip value is transferred to an individual (or individual account) associated with the second user computer such as a server or other individual who may receive tips.

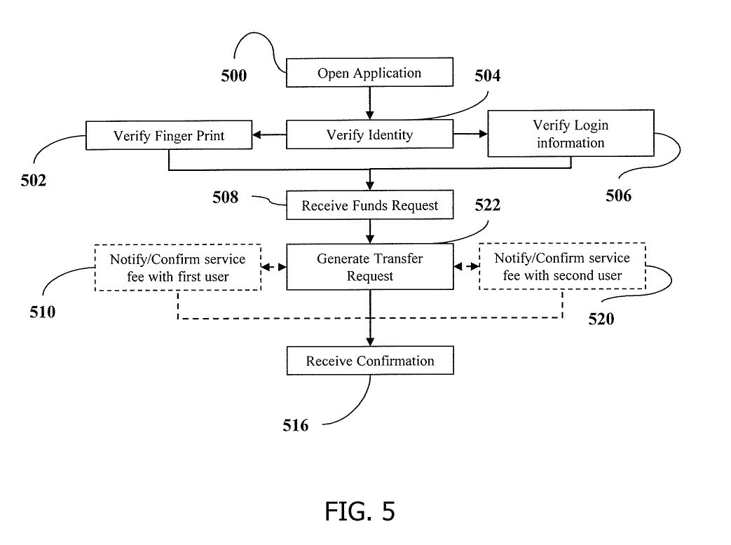

In FIG. 5 an exemplary method implemented by a user device is shown. The software or application 500 is opened on the first user device. The identity is verified 504 using a login. In some cases, a biometric sensor may have been used to allow the first user device to unlock, therefore, the identity may have already been verified 504 prior to opening the application 500. In some cases, the application may require verification using a finger print 502 or login information 506. The verification can occur prior to opening the application, once the application is opened or both. A funds request is received 508, for example, the first user may press a button indicating that they are requesting coin value (see FIG. 1). A transfer request is generated 522 based on the funds request and optionally using data accessed or retrieved from a database or storage such as account number, routing number, account address, owner or other relevant banking or user information. Any service fees or rewards can be confirmed with the first and/or second users 510, 520. The transfer is then verified to have been completed, for example, by receiving a confirmation 516. This confirmation can be received from the second user computer, a financial institution computer or the system computer.

It is understood that a website may be created with a user interface that allows the user to access data, transfer funds and request and/or generate reports discussed herein.

It is further contemplated that the system can allow a user to compare their savings whether daily, weekly or other to an online social network, and the system can allow users to invite friends to create an account with the system. Further, the system may be designed to track referrals so that users can be rewarded for inviting others to use the system.

The website, application or system may further allow various users to transfer money between provider managed accounts and third party financial institutions. In addition, the website may receive selections of settings or rules that determine if where transferred funds are sent. For example, the system may be configured to automatically transfer all funds to a bank account or to transfer funds to the bank account once a threshold balance is obtained.

It is also contemplated that the system can be configured to allow users of the system to donate their change or a portion thereof to charity. It is contemplated that the user can designate one or multiple charities as recipients and the user can further designate various percentages of change to donate to charity. It is further contemplated that the reporting feature discussed in relation to sales tax can further be implemented to report charitable donations for tax filing purposes, and it is also contemplated that the system can be configured to allow tax preparation software or tax preparation providers to access the reports and/or data. It is further contemplated that the service fee may be reduced, eliminated or donated by the system computer when transferring funds to charities. Reports can likewise track charitable contributions for tax reporting as discussed herein.

It is further contemplated that the system can be configured to allow funds to be transferred to other third party accounts, for example, gift cards, iTunes store, charity/foundation, mobile wallets for example; Google wallet; LevelUp; GoPago, etc. It is further contemplated that the system can be configured to transfer funds to a money market, savings, mutual fund, brokerage account, retirement accounts or other investment or security account.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for transferring funds from a first user to a second user comprising:
software executing on a first user device for transmitting a funds request via a first wireless communication system;
software executing on a second user computer for receiving the funds request from said first user device via a second wireless communication system, the funds request indicative of at least part of a residual amount due to the first user as a result of a cash transaction with the second user;
a system computer in communication with said second user computer via a network;
software executing on said system computer for transmitting a transfer request based on the funds request, the transfer request for electronically transferring the at least part of the residual amount from a second user account to a first user account.

2. The system of claim 1 further comprising: software executing on said system computer for generating a confirmation based on said transfer request, said confirmation indicative of a successful transfer of the residual amount from the second user account to the first user account.

3. The system of claim 2 wherein said confirmation is transmitted to at least one of said second user computer or said first user device.

4. The system of claim 1 wherein the residual amount is the amount of change due to the first user as a result of a cash transaction with the second user.

5. The system of claim 1 wherein the funds request is indicative of the value of coins due to the first user as a result of a cash transaction with the second user; and further comprising:
software executing on said second user computer for displaying a cash value due to the first user as a result of the cash transaction, where the cash value is the residual amount minus coin value.

6. The system of claim 1 further comprising software executing on said system computer for verifying an identity of the first user and associating the first user with the user account.

7. The system of claim 1 further comprising: software executing on said system computer for deducting a service fee from the residual amount and transferring the service fee to a provider account, wherein the at least a part of the residual amount is the amount due to the first user as a result of the cash transaction less the service fee.

8. The system of claim 1 wherein the second user account includes at least two accounts, one said two accounts is a second user third party account, one said two accounts is a second user provider account, the system further comprising:
software executing on said system computer for determining a balance of at least one of the two accounts;
software executing on said system computer for comparing the residual amount to the balance and to determine which of the at least two accounts has sufficient funds for completing the transfer;
software executing on said system computer for determining a service fee for each of the account based on an amount transferred from each of the two accounts;
software executing on said system computer for determining a percentage to deduct from each of the two accounts in order to obtain the lowest service fee.

9. The system of claim 1 wherein the funds request is indicative of a tip value and the tip value is deducted from the residual amount so that the residual amount indicates the amount due to the user as a result of the cash transaction less tips.

10. A computer implemented method for transferring funds from a first user to a second user comprising the steps of:
providing software executable on a processor of a first user device and for generating a funds request;
receiving a funds request transmitted from the first user device to a second user device over a wireless communication system, the funds request indicative of at least part of a residual amount due to the first user as a result of a cash transaction with the second user;
verifying an identity of the first user;
generating a transfer request based on the funds request, the transfer request indicative of a transfer and for electronically transferring at least part of the residual amount from a second user account to a first user account.

11. The method of claim 10 wherein said verifying step is completed by receiving first user account information.

12. The method of claim 10 wherein a biometric sensor associated with a first user device generates a first user identifier for transmission to said second user device; and wherein said first user identifier is used to complete said verifying step.

13. The method of claim 10 further comprising:
said step of receiving a funds request further includes receiving a tip request indicative of a tip value that the first user would like to transfer to an individual associated with the second user computer;
electronically transferring coin value due to the first user after tips due to the first user account;
indicating on a display of said second user computer a cash value due to the first user after deduction of tips and coin value.

14. The method of claim 13 wherein the biometric sensor is selected from the group consisting of: fingerprint sensor, retinal scanner and facial recognition sensor.

15. A software application for transferring funds from a first user to a second user comprising:
software executing on a first user device for communicating with a second user computer via a wireless communication system;
software executing on said first user device for displaying at least two user selectable options;
a first one of the options indicative of a fund request for requesting a change value due to the first user as a result of a cash transaction with the second user;
a second one of the options indicative of a fund request for requesting a coin value due to the first user as a result of a cash transaction with the second user;
software executing on said first user device for receiving a selection of one of the first or second options and for further transmitting the fund request associated with the selected option to the second user computer.

16. The application of claim 15 further comprising:
software executing on said first user device for displaying a service fee associated with the fund request associated with the selected option;
software executing on said first user device for displaying a user selectable confirmation option;
software executing on said first user device for receiving a selection of said confirmation option, said selection indicative of the first user's acceptance of the service fee, wherein the fund request is transmitted to the system computer upon receiving the selection of said confirmation option.

17. The application of claim 15 wherein the transfer request is for transferring funds from a second user account to a first user account, the application further comprising:
software executing on said first user device computer for receiving a verification identifier, wherein the verification identifier indicates that the fund request was initiated by the individual associated with the first user account.

18. The application of claim 17 further comprising:
a third user selectable option displayed on the user device, the third option indicative of a tip value the first user would like deducted from the residual amount due to the first user.

19. The system of claim 18 wherein said verification identifier is generated by a biometric sensor associated with said first user device.

20. A system for transferring funds from a first user to a second user comprising:
a first user device having a first user identifier associated therewith said first user identifier associated with a first user account;
a second user computer having a wireless communication system associated therewith and for communication with said first user device in order to read the first user identifier from said first user device;
software executing on said second user computer for communicating a fund request and said first user identifier to a system computer over a network connection, said fund request indicative of at least part of a residual amount due to the first user as a result of a cash transaction with the second user;
software executing on said system computer for querying a database with said first user identifier to determine a first user setting, the first user setting indicative of if the first user would like either: a transfer of change to the first user account, or a transfer of coin value to the first user account;
software executing on said system computer for generating a transfer request based on the first user setting and for transferring at least part of the residual amount to the first user account.

21. The system of claim 20 wherein said first user device is a mobile computing device having a processor with software executing thereon; and
wherein the wireless communication system is a near field communication system.

22. The system of claim 20 further comprising:
software executing on said system computer for generating a confirmation based on said transfer request, said confirmation indicative of a successful transfer of the residual amount from the second user account to the first user account;
software executing on said system computer for transmitting said confirmation to a mobile device associated with the first user.

23. The system of claim 22 wherein the mobile device is said first user device.

24. The system of claim 20 further comprising:
software executing on said system computer for calculating a service fee associated with said transfer request;
software executing on said system computer for transferring said service fee to a provider account.

25. The system of claim 24 further comprising:
software executing on said system computer for calculating a reward associated with said transfer request and for transferring said reward to a second user account.
